(19) United States
(12) Patent Application Publication
(10) Pub. No.: US 2015/0168135 A1
(43) Pub. Date: Jun. 18, 2015

(54) AUTOMATIC TEXTURE RECOGNITION APPARATUS AND METHOD BASED ON HOLOGRAPHY

(71) Applicant: Electronics and Telecommunications Research Institute, Daejeon (KR)

(72) Inventors: Nac Woo KIM, Seoul (KR); Seung Chul SON, Gwangju (KR); Seok Kap KO, Gwangju (KR); Byung-Tak LEE, Gwangju (KR); Young Sun KIM, Gwangju (KR)

(73) Assignee: Electronics and Telecommunications Research Institute, Daejeon (KR)

(21) Appl. No.: 14/286,255

(22) Filed: May 23, 2014

(30) Foreign Application Priority Data
Dec. 13, 2013 (KR) 10-2013-0155605

(51) Int. Cl. G01B 11/25; G02B 13/00; G06K 9/62; G06T 7/20; G06T 17/00

(52) U.S. Cl. CPC G01B 11/254; G06T 7/20; G06T 17/00; G06K 9/6267; G02B 13/00

(57) ABSTRACT

Provided is an automatic texture recognition apparatus. The automatic texture recognition apparatus includes a light irradiation unit irradiating, to a subject, a light modulation pattern generated according to a synchronization control signal and a pattern control signal; a hybrid optical sensor taking an image of the subject to generate an image input signal; a texture recognition unit using the image input signal to recognize a 2D texture of the subject; and a control unit generating the synchronization control signal and the pattern control signal, wherein the texture recognition unit transmits a process result according to whether the 2D texture of the subject is recognized, the control unit generates the pattern control signal and the synchronization control signal for changing the light modulation pattern according to the process result.

### CROSS-REFERENCE TO RELATED APPLICATIONS

This U.S. non-provisional patent application claims priority under 35 U.S.C. §119 of Korean Patent Application No. 10-2013-0155605, filed on Dec. 13, 2013, the entire contents of which are hereby incorporated by reference.

### BACKGROUND OF THE INVENTION

The present invention disclosed herein relates to a recognition apparatus and more particularly, to an automatic texture recognition apparatus and method based on holography.

With the recent development of an image media technology, massive multimedia data is sharply increasing. Thus, technologies to effectively index, classify or search for images or videos are being widely used. MPEG7 is being gradually utilized as a multimedia search standard. In particular, MPEG7 compact descriptor visual search (CDVS) standard is also being newly utilized for an image search in a mobile environment. A characteristic representing element that represents an image is needed for such an image search. The color, shape, texture and motion of a subject object are being used as the characteristic representing element for an image search. Among others, the texture is one of important elements that show the characteristics of a subject.

### SUMMARY OF THE INVENTION

The present invention provides an automatic texture recognition apparatus and method that recognizes a 2D texture of a subject and obtains 3D texture information based on holography.

According to example embodiments of the inventive concept, an automatic texture recognition apparatus may include a light irradiation unit irradiating, to a subject, a light modulation pattern generated according to a synchronization control signal and a pattern control signal; a hybrid optical sensor taking an image of the subject to generate an image input signal; a texture recognition unit using the image input signal to recognize a 2D texture of the subject; and a control unit generating the synchronization control signal and the pattern control signal, wherein the texture recognition unit transmits a process result according to whether the 2D texture of the subject is recognized, the control unit generates the pattern control signal and the synchronization control signal for changing the light modulation pattern according to the process result, and the synchronization control signal is generated to synchronize the operations of the light irradiation unit, the hybrid optical sensor, and the texture recognition unit.

In some embodiments, the texture recognition unit may include: a texture input unit receiving the image input signal from the hybrid optical sensor; a texture processing unit using the image input signal to recognize the 2D texture of the subject; and a texture classifying unit classifying and storing the 2D texture of the subject, wherein the image input signal may include a first 2D subject image, a second 2D subject image including the light modulation pattern, an object beam and a reference pattern image.

In other embodiments, the texture processing unit may compare the first 2D subject image with the second 2D subject image including the light modulation pattern to recognize a 2D texture of the subject.

In still other embodiments, the texture processing unit may generate a 3D hologram of the subject through holography using the object beam and the reference pattern image.

In even other embodiments, the texture processing unit may generate a 3D texture of the subject by using the 2D texture and 3D hologram of the subject.

In yet other embodiments, the texture classifying unit may classify and store the 3D texture of the subject for enabling an easy search.

In further embodiments, the texture input unit may digitalize the input image signal and transmit a digitalized signal to the texture processing unit.

In still further embodiments, the texture processing unit may transmit the process result for changing the light modulation pattern when failing in recognizing the 2D texture of the subject.

In even further embodiments, the light irradiation unit may include: a laser unit outputting a laser light signal according to the synchronization control signal; a beam splitter splitting the laser light signal into a first and a second spectral signal; a frequency/phase modulator changing a frequency or phase of the first spectral signal according to the pattern control signal to generate a first modulated signal; a first diffractive optical element performing active filtering on the first modulated signal according to the pattern control signal to generate a first filtered signal; a second diffractive optical element performing active filtering on the second spectral signal according to the pattern control signal to generate a second filtered signal; and an optical scanner using the first and the second filtered signals to generate the light modulation pattern.

In yet further embodiments, the first and the second diffractive optical elements may simultaneously transmit the first and the second filtered signals to the optical scanner according to the synchronization control signal.

In much further embodiments, the first and the second diffractive optical elements may distribute the first modulated signal and the second spectral signal through the active filtering or change shapes or intensities of the first modulated signal and the second spectral signal.

In still much further embodiments, the laser unit may determine the frequency or phase of the laser light signal according to the pattern control signal.

In even much further embodiments, the control unit may include: a pattern control unit generating the pattern control signal to change the light modulation pattern according to the process result; and a synchronization control unit generating the synchronization control signal to synchronize operations of the light irradiation unit, the hybrid optical sensor, and the texture recognition unit, according to the process result.

In other embodiments of the present invention, automatic texture recognition methods include generating a first light modulation pattern according to a first synchronization control signal and a first pattern control signal; irradiating the first light modulation pattern to a subject; taking a picture of the subject through a hybrid optical sensor and receiving a first image input signal; using the first image input signal to recognize a 2D texture of the subject; and generating a process result according to whether the 2D texture of the subject is recognized; generating a second synchronization control signal and a second pattern control signal according to the process result; generating a second light modulation pattern different from the first light modulation pattern according to the second synchronization control signal and the second pattern control signal; and irradiating the second light modulation pattern to the subject and receiving a second image input signal through the hybrid optical sensor.

In some embodiments, the first image input signal may include a first 2D subject image and a second 2D subject image including he first light modulation pattern, and the 2D texture of the subject texture may be recognized by comparing the first 2D subject image with the first 2D subject image including the first light modulation pattern.

In other embodiments, when generating the second synchronization control signal and the second pattern control signal according to the process result, the process result may correspond to when failing in recognizing the 2D texture of the subject.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention.

FIG. 1 is a block diagram of an automatic texture recognition apparatus according to an embodiment of the present invention.

FIG. 2 is a block diagram specifying a light irradiation unit of FIG. 1.

FIG. 3 is a block diagram specifying an embodiment of a control unit of FIG. 1.

FIG. 4 is a block diagram specifying another embodiment of a control unit of FIG. 1.

FIG. 5 is a block diagram specifying a texture recognizing unit of FIG. 1.

FIG. 6 illustrates a light modulation pattern generated by a light irradiation unit of FIG. 1.

FIG. 7 illustrates a method of irradiating a light modulation pattern by a light irradiation unit of FIG. 1.

FIG. 8 is a flow chart of a method of generating a light modulation pattern by a light irradiation unit of FIG. 1.

FIG. 9 is a flow chart of the operation method of an automatic texture recognition apparatus of FIG. 1.

### DETAILED DESCRIPTION OF PREFERRED EMBODIMENTS

It should be understood that both the foregoing general description and the following detailed description are exemplary, and it should be appreciated that the additional description of the claimed invention is provided. Reference numerals are indicated in the exemplary embodiments of the present invention and their examples are indicated in the accompanying drawings. The same reference numerals are used in the description and drawings in order to refer to the same or similar parts wherever possible.

In the following, an automatic texture recognition apparatus will be used as an example of an electrical apparatus for describing the characteristics and functions of the present invention. However, a person skilled in the art will be able to easily understand other advantages and performance of the present invention based on the details described herein. Also, the present invention will be able to be implemented or applied through other embodiments. In addition, the detailed description may be modified or changed according to a viewpoint and an application without departing significantly from the scope, technical spirit and other purposes of the present invention.

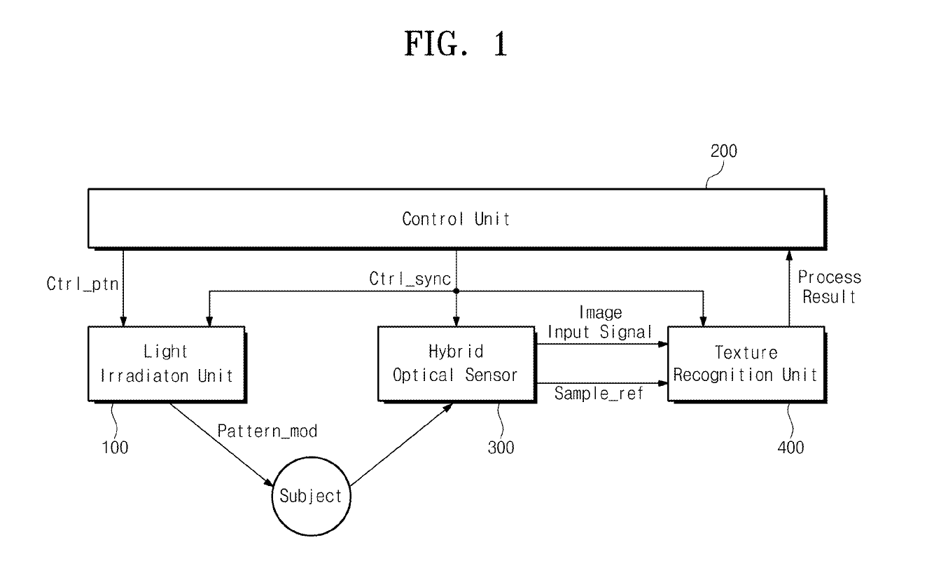

FIG. 1 is a block diagram of an automatic texture recognition apparatus according to an embodiment of the present invention. Referring to FIG. 1, the automatic texture recognition apparatus may include a light irradiation unit 100, a control unit 200, a hybrid optical sensor 300 and a texture recognition unit 400.

The light irradiation unit 100 may generate a light modulation pattern Pattern_mod according to a synchronization control signal Ctrl_sync and a pattern control signal Ctrl_ptn. The light irradiation unit 100 may perform the following processes in order to generate the light modulation pattern Pattern_mod. The light irradiation unit 100 may generate a laser light signal that has a single frequency and phase. The frequency and phase of the laser light signal may be determined according to the pattern control signal Ctrl_ptn. The generation time of the laser light signal may be determined according to the synchronization control signal Ctrl_sync. The light irradiation unit 100 may split a generated laser light signal into a first and a second spectral signal. The first and the second spectral signal may have the same frequency and phase. The light irradiation unit 100 may change the frequency or phase of the first spectral signal or the second spectral signal in order to generate various light modulation patterns Pattern_mod. The light irradiation unit 100 modulates the frequency or phase of the first spectral signal or the second spectral signal to generate the interference waveform between the two signals. By various changes of the frequency or phase of the first spectral signal or the second spectral signal, the light irradiation unit 100 may generate various light modulation patterns Pattern_mod. The light irradiation unit 100 may perform active filtering on the first and the second spectral signals and generate a first and a second filtered signal in order to implement various shapes of light modulation patterns Pattern_mod. The light irradiation unit 100 may combine the first and the second filtered signals and generate various shapes of light modulation patterns Pattern_mod. The generated light modulation pattern Pattern_mod may be irradiated to a subject to obtain texture information on the subject.

Also, in another embodiment of the present invention, the light irradiation unit 100 may generate a first and a second laser light signal having different frequencies or phases without splitting a laser light into the first and the second spectral lights. The light irradiation unit 100 may change the frequency or phase of the first laser light signal or the second laser light signal and then perform active filtering thereon to generate the first and the second filtered signals. In the following, a case where a laser light signal is used will be exemplarily described.

The control unit 200 may generate the synchronization control signal Ctrl_sync and the pattern control signal Ctrl_ptn. At the initial operation of the automatic texture recognition apparatus, the control unit 200 may generate the synchronization control signal Ctrl_sync and the pattern control signal Ctrl_ptn to start generating the light modulation pattern Pattern_mod.

The synchronization control signal Ctrl_sync may be transmitted to the light irradiation unit 100, the hybrid optical sensor 300 and the texture recognition unit 400. When the light modulation pattern Pattern_mod is irradiated, the hybrid optical sensor 300 may operate according to the synchronization control signal Ctrl_sync. When the hybrid optical sensor 300 operates, the texture recognition unit 400 may receive an image input signal according to the synchronization control signal Ctrl_sync. The light irradiation unit 100 may or may not irradiate the light modulation pattern Pattern_mod at regular intervals according to the synchronization control signal Ctrl_sync.

The pattern control signal Ctrl_ptn may be transmitted to the light irradiation unit 100. The light irradiation unit 100 may generate various light modulation patterns Pattern_mod according to the pattern control signal Ctrl_ptn. The light irradiation unit 100 may determine the frequency and phase of the laser light signal according to the pattern control signal Ctrl_ptn. The light irradiation unit 100 may change the frequency or phase of the first spectral signal or the second spectral signal according to the pattern control signal Ctrl_ptn. The light irradiation unit 100 may adjust active filtering according to the pattern control signal Ctrl_ptn. Thus, the light modulation pattern Pattern_mod may be variously generated according to the pattern control signal Ctrl_ptn.

The control unit 200 may receive a process result from the texture recognition unit 400 and generate the synchronization control signal Ctrl_sync and the pattern control signal Ctrl_ptn. For example, the process result may include two facts.

First, the process result may include the fact that the light modulation pattern Pattern_mod irradiated to a subject matches or resembles the texture of the subject. In this case, the control unit 200 may generate the synchronization control signal Ctrl_sync and the pattern control signal Ctrl_ptn to stop generating the light modulation pattern Pattern_mod.

Second, the process result may include the fact that the light modulation pattern Pattern_mod irradiated to the subject does not match or resemble the texture of the subject. In this case, the control unit 200 may generate the synchronization control signal Ctrl_sync and the pattern control signal Ctrl_ptn to generate a new light modulation pattern Pattern_mod.

The hybrid optical sensor 300 may take an image of the subject. For example, the hybrid optical sensor 300 may include an image sensor or a light receiving sensor. The hybrid optical sensor 300 may take an image of the subject according to the synchronization control signal Ctrl_sync and transmit an image input signal to the texture recognition unit 400. The image input signal may include a 2D subject image, a 2D subject image including the light modulation pattern Pattern_mod, and an object beam for generating a 3D hologram. Also, the hybrid optical sensor 300 may obtain a reference pattern image Sample_ref for generating a 3D hologram. The reference pattern image Sample_ref is used to generate a 3D hologram of the subject along with the object beam. The reference pattern image Sample_ref may be obtained by optically splitting the light modulation pattern irradiated by the light irradiation unit 100. The hybrid optical sensor 300 may receive a signal of the light modulation patterns Pattern_mod obtained through splitting. Also, the reference pattern image Sample_ref may utilize the object beam that is previously obtained by the hybrid optical sensor 300.

The texture recognition unit 400 may receive an image input signal from the hybrid optical sensor 300 according to the synchronization control signal Ctrl_sync. The image input signal may include a 2D subject image, a 2D subject image including the light modulation pattern Pattern_mod, and an object beam for generating a 3D hologram. The texture recognition unit 400 may compare the 2D subject image with the 2D subject image including the light modulation pattern Pattern_mod and recognize the 2D texture of a subject. The 2D subject image and the 2D subject image including the light modulation pattern Pattern_mod may be alternately received at regular time intervals according to the synchronization control signal Ctrl_sync. The texture recognition unit 400 may receive the reference pattern image Sample_ref through the hybrid optical sensor 300. The texture recognition unit 400 may use the reference pattern image Sample_ref and the object beam to generate the 3D hologram of a subject. The texture recognition unit 400 may compare the 2D subject image with the 2D subject image including the light modulation pattern Pattern_mod and output a process result. The process result may be transmitted to the control unit 200. The control unit 200 may generate the synchronization control signal Ctrl_sync and the pattern control signal Ctrl_ptn according to the process result. The light irradiation unit 100 may generate a new light modulation pattern Pattern_mod according to the process result. When the light modulation pattern Pattern_mod matches or resembles the texture of the subject, the texture recognition unit 400 may generate a 2D texture and a 3D hologram. The texture recognition unit 400 may store the generated 2D texture and 3D hologram. The texture recognition unit 400 may use the 2D texture and 3D hologram to map a 3D texture. The texture recognition unit 400 may classify and store the mapped 3D texture for enabling an easy search.

By using the above configuration, the automatic texture recognition apparatus may generate various light modulation patterns Pattern_mod. The automatic texture recognition apparatus may irradiate the generated light modulation pattern Pattern_mod to a subject. After irradiating the light modulation pattern Pattern-mod, the automatic texture recognition apparatus may receive a 2D subject image, a 2D subject image including the light modulation pattern, an object beam and a reference pattern image Sample_ref. The automatic texture recognition apparatus may compare the 2D subject image with the 2D subject image including the light modulation pattern Pattern_mod and recognize the 2D texture of a subject. When the light modulation pattern Pattern_mod does not match or resemble the texture of the subject, the automatic texture recognition apparatus may generate a new light modulation pattern Pattern_mod and irradiate the generated pattern to the subject. Until the light modulation pattern Pattern_mod matches or resembles the texture of the subject, the automatic texture recognition apparatus may continue to change the light modulation pattern Pattern_mod. When the light modulation pattern Pattern_mod matches or resembles the texture of the subject, the automatic texture recognition apparatus may recognize the 2D texture of the subject. In this case, the automatic texture recognition apparatus may use the object beam and the reference pattern image Sample_ref to generate a 3D hologram of the subject. The automatic texture recognition apparatus may store the generated 2D texture and 3D hologram. The automatic texture recognition apparatus may use the 2D texture and 3D hologram of the subject to map a 3D texture. The automatic texture recognition apparatus may classify and store a mapped 3D texture. The mapped 3D texture may be used for enabling an easy search for the subject. Thus, the automatic texture recognition apparatus may utilize both 2D based texture information and 3D based texture information for processing and classifying a texture.

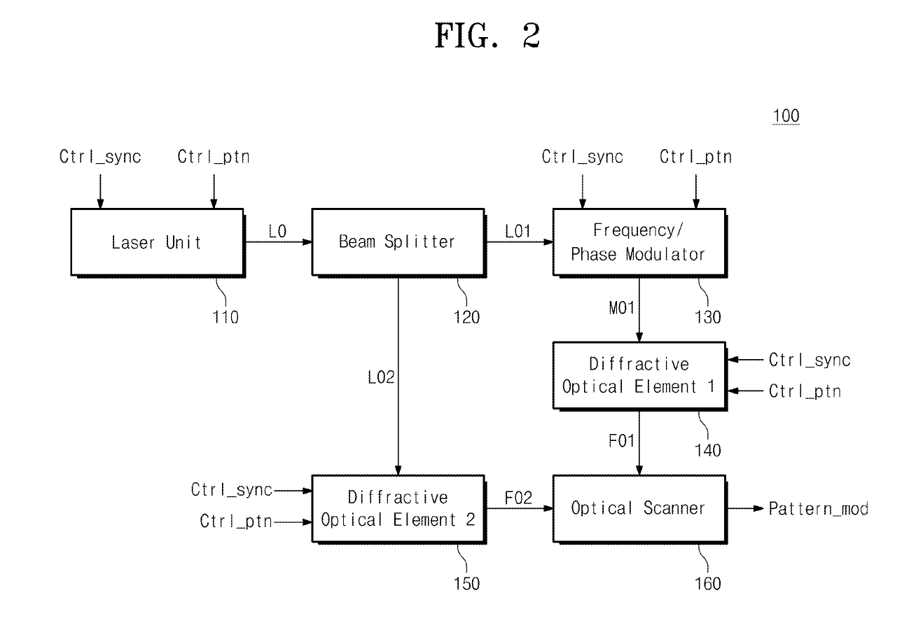

FIG. 2 is a block diagram specifying a light irradiation unit of FIG. 1. Referring to FIG. 2, the light irradiation unit 100 may include a laser unit 110, a beam splitter 120, a frequency/phase modulator 130, a first diffractive optical element 140, a second diffractive optical element 150 and an optical scanner 160.

The light irradiation unit 110 may output a laser light signal L0 according to the synchronization control signal Ctrl_sync and the pattern control signal Ctrl_ptn. The light irradiation unit 110 may determine the frequency and phase of the laser light signal L0 according to the pattern control signal Ctrl_ptn. For example, the laser light signal L may be a signal that has a single frequency and phase. The laser unit 110 may output the laser light signal L0 at a time preset according to the synchronization control signal Ctrl_sync. Also, in another embodiment of the present invention, the laser unit may generate a first and a second laser light signal having different frequencies and phases although not shown in FIG. 2. The laser unit 110 may transmit the first laser light signal to the frequency/phase modulator 130. The laser unit 110 may transmit the second laser light signal to the second diffractive optical element 150. In the following, a case where the laser light signal L0 is used will be exemplarily described.

The beam splitter 120 may split the received laser light signal L0 into a first and a second spectral signal L01 and L02. The first and the second spectral signals may have the same frequency and phase. The first spectral signal L01 may be transmitted to the frequency/phase modulator 130. The second spectral signal L02 may be transmitted to the second diffractive optical element 150.

The frequency/phase modulator 130 may change the frequency or phase of the received first spectral signal L01 and generate a first modulated signal M01. The frequency/phase modulator 130 may change the frequency or phase of the first spectral signal L01 according to the pattern control signal Ctrl_ptn. The frequency/phase modulator 130 may change the frequency or phase of the first spectral signal L01 in order to generate various light modulation patterns Pattern_mod.

Thus, the first modulated signal M01 has a different frequency or phase from the second spectral signal L02. The first modulated signal M01 may be transmitted to the first diffractive optical element 140 according to the synchronization control signal Ctrl_sync.

The first diffractive optical element 140 may change the first modulated signal M01 to a first filtered signal F01. For example, the first diffractive optical element 140 may distribute the first modulated signal M01 according to the pattern control signal Ctrl_ptn and change it to the first filtered signal F01. The first diffractive optical element 140 may adjust the shape or intensity of the first modulated signal M01 through active filtering. The first filtered signal F01 may be transmitted to the optical scanner 160 according to the synchronization control signal Ctrl_sync.

The second diffractive optical element 150 may change the second spectral signal L02 to a second filtered signal F02. For example, the second diffractive optical element 150 may distribute the second spectral signal L02 according to the pattern control signal Ctrl_ptn and change it to the second filtered signal F02. The second diffractive optical element 150 may adjust the shape or intensity of the second spectral signal L02 through active filtering. The second filtered signal F02 may be transmitted to the optical scanner 160 according to the synchronization control signal Ctrl_sync.

The first and the second diffractive optical elements 140 and 150 may be of e.g., a liquid crystal type. However, the first and the second diffractive optical elements are not limited thereto. The first and the second filtered signals F01 and F02 may be together transmitted to the optical scanner 160 according to the synchronization control signal Ctrl_sync.

The optical scanner 160 may receive the first and the second filtered signals F01 and F02 together. The optical scanner 160 may use the first and the second filtered signals F01 and F02 to generate the light modulation pattern Pattern_mod. The optical scanner 160 may use the interference between the first and the second filtered signals F01 and F02 to generate various light modulation patterns Pattern_mod. The generated light modulation pattern Pattern_mod may be irradiated to a subject.

Each signal described above may have a path changed by a reflecting unit (e.g., mirror) although not shown in FIG. 2.

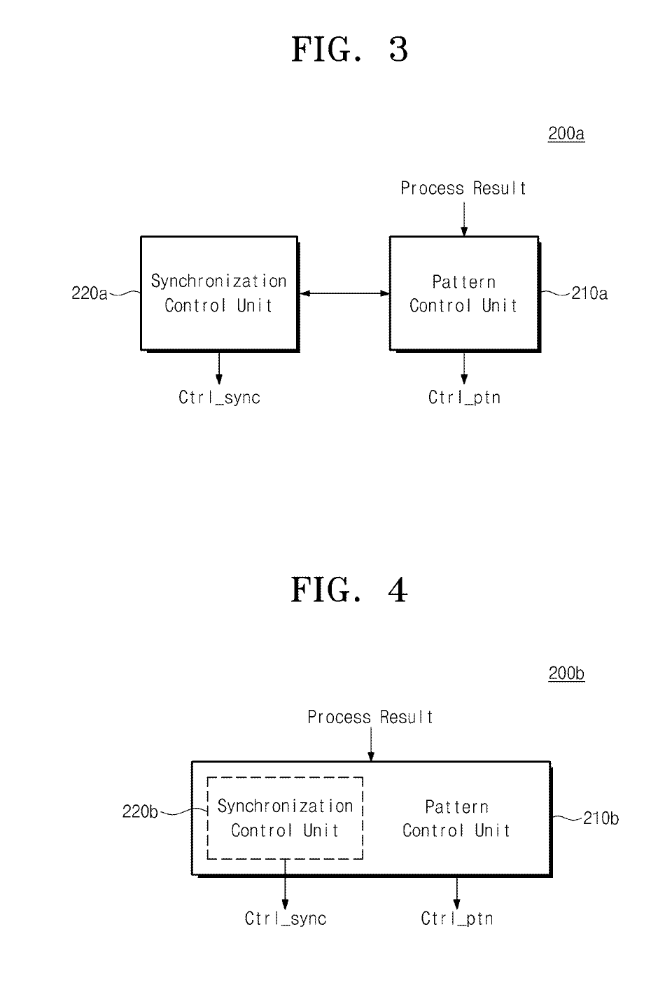

FIG. 3 is a block diagram specifying an embodiment of a control unit of FIG. 1. Referring to FIG. 3, a control unit 200a may include a pattern control unit 210a and a synchronization control unit 220a. The control unit 200a may generate the synchronization control signal Ctrl_sync and the pattern control signal Ctrl_ptn for generating the light modulation pattern Pattern_mod that is set at the initial operation of the automatic texture recognition apparatus.

The pattern control unit 210a may receive a process result from the texture recognition unit 400. The pattern control unit 210a may generate the pattern control signal Ctrl_ptn to generate a new light modulation pattern Pattern_mod according to a received process result. For example, the process result may include information that a irradiated light modulation pattern Pattern_mod irradiated does not match or resemble the texture of a subject. The pattern control unit Ctrl_ptn may be transmitted to the laser unit 110 of the light irradiation unit 100, the frequency/phase modulator 130, and the first and the second diffractive optical elements 140 and 150. For example, the pattern control unit Ctrl_ptn may include information on a frequency and phase to be provided to the laser unit 110, the frequency/phase modulator 130, and the first and the second diffractive optical elements 140 and 150. The pattern control unit 210a may exchange information with the synchronization control unit 220a. The pattern control unit 210a may provide information on generating the synchronization control signal Ctrl_sync to the synchronization control unit 220a. The pattern control unit 210a may transmit a process result to the synchronization control unit 220a.

The synchronization control unit 220a may generate the synchronization control signal Ctrl_sync according to a process result received from the pattern control unit 210a. The synchronization control signal Ctrl_sync may be transmitted to the light irradiation unit 100, the hybrid optical sensor 300 and the texture recognition unit 400. The synchronization control signal Ctrl_sync may include information on the operation times of the light irradiation unit 100, the hybrid optical sensor 300 and the texture recognition unit 400. The synchronization control signal Ctrl_sync may be transmitted to the laser unit 110 of the light irradiation unit 100, the frequency/phase modulator 130, and the first and the second diffractive optical elements 140 and 150. The laser unit 110 may output the laser light signal L0 according to the synchronization control signal Ctrl_sync. The frequency/phase modulator 130 may transmit the first modulated signal M01 to the first diffractive optical element 140 according to the synchronization control signal Ctrl_sync. The first and the second diffractive optical elements 140 and 150 may together transmit the first and the second filtered signals F01 and F02 to the optical scanner 160 according to the synchronization control signal Ctrl_sync. Thus, the optical scanner 160 may use the interference between the first and the second filtered signals F01 and F02 to generate the light modulation pattern Pattern_mod. Also, the light irradiation unit 100 may irradiate different light modulation patterns Pattern_mod to a subject at regular intervals according to the synchronization control signal Ctrl_sync. The synchronization control unit 220a may exchange information with the pattern control unit 210a and receive a process result. Also, in another embodiment, it is possible to receive the process result directly from the texture recognition unit 400 although not shown in FIG. 3.

FIG. 4 is a block diagram specifying another embodiment of a control unit of FIG. 1. Referring to FIG. 4, a synchronization control unit 200b may be included in a pattern control unit 210b.

The pattern control unit 210b may receive a process result from the texture recognition unit 400. The pattern control unit 210b may generate the pattern control signal Ctrl_ptn to generate a new light modulation pattern Pattern_mod according to a received process result. For example, the process result may include information that a irradiated light modulation pattern Pattern_mod irradiated does not match or resemble the texture of a subject. The pattern control signal Ctrl_ptn may be transmitted to the laser unit 110 of the light irradiation unit 100, the frequency/phase modulator 130, and the first and the second diffractive optical elements 140 and 150. For example, the pattern control signal Ctrl_ptn may include information on a frequency and phase to be provided to the laser unit 110, the frequency/phase modulator 130, and the first and the second diffractive optical elements 140 and 150. The pattern control unit 210b may control the synchronization control unit 220a to generate the synchronization control signal Ctrl_sync.

The synchronization control unit 220b may generate the synchronization control signal Ctrl_sync according to the control of the pattern control unit 210b. The synchronization control signal Ctrl_sync may be transmitted to the light irradiation unit 100, the hybrid optical sensor 300 and the texture recognition unit 400. The synchronization control signal Ctrl_sync may include information on the operation times of the light irradiation unit 100, the hybrid optical sensor 300 and the texture recognition unit 400. The synchronization control signal Ctrl_sync may be transmitted to the laser unit 110 of the light irradiation unit 100, the frequency/phase modulator 130, and the first and the second diffractive optical elements 140 and 150. The laser unit 110 may output the laser light signal L0 according to the synchronization control signal Ctrl_sync. The frequency/phase modulator 130 may transmit the first modulated signal M01 to the first diffractive optical element 140 according to the synchronization control signal Ctrl_sync. The first and the second diffractive optical elements 140 and 150 may together transmit the first and the second filtered signals F01 and F02 to the optical scanner 160 according to the synchronization control signal Ctrl_sync. Thus, the optical scanner 160 may use the interference between the first and the second filtered signals F01 and F02 to generate the light modulation pattern Pattern_mod. Also, the light irradiation unit 100 may irradiate different light modulation patterns Pattern_mod to a subject at regular intervals according to the synchronization control signal Ctrl_sync.

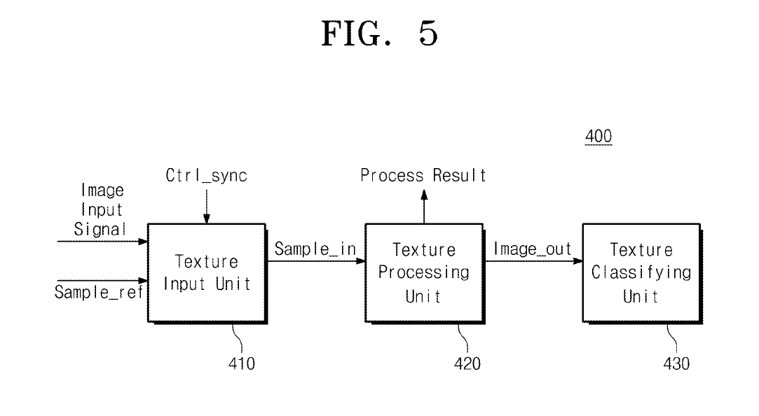

FIG. 5 is a block diagram specifying a texture recognizing unit of FIG. 1. Referring to FIG. 5, the texture recognition unit 400 may include a texture input unit 140, a texture processing unit 420, and a texture classifying unit 430.

The texture input unit 410 may receive an image input signal and a reference pattern image Sample_ref from the hybrid optical sensor 300 according to the synchronization control signal Ctrl_sync. The texture input unit 410 may receive the image input signal at the irradiation time of the light modulation pattern Pattern_mod to the subject according to the synchronization control signal Ctrl_sync. The texture input unit may convert a received image input signal into an input sample signal Sample_in digitalized to a bit set per sample. The input sample signal Sample_in may include a 2D subject image, a 2D subject image including the light modulation pattern Pattern_mod, an object beam and a reference pattern image Sample_ref for generating a 3D hologram. The input sample signal Sample_in may be transmitted to the texture processing unit 420.

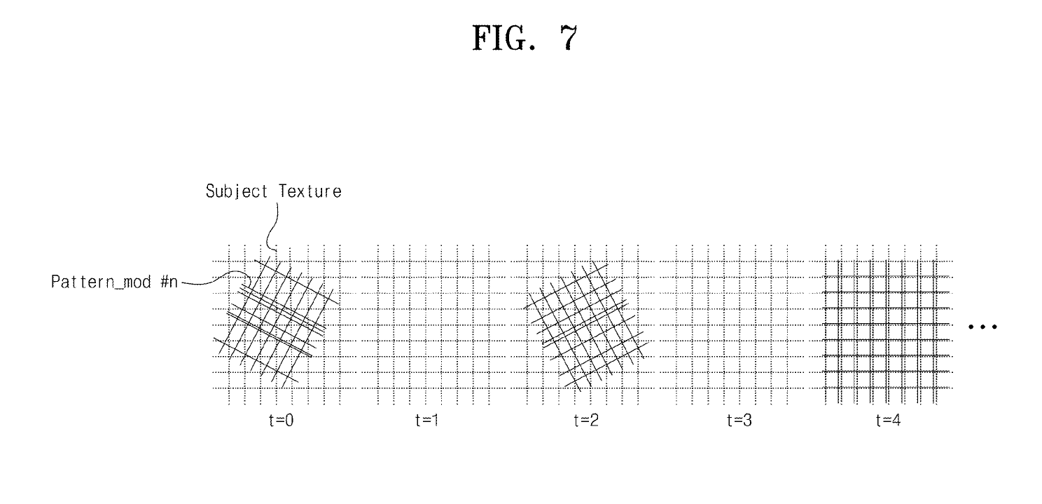

The texture processing unit 420 may receive the input sample signal from the texture input unit 410. The input sample signal Sample_in may include a 2D subject image, and a 2D subject image including the light modulation pattern Pattern_mod. The texture processing unit 420 may compare the 2D subject image with the 2D subject image including the light modulation pattern Pattern_mod and recognize the 2D texture of a subject. The 2D subject image and the 2D subject image including the light modulation pattern Pattern_mod may be alternately received at regular time intervals. A related description is provided in detail with reference to FIG. 7. Also, the input sample signal Sample_in may include an object beam and a reference pattern image Sample_ref for generating a 3D hologram. The texture processing unit 420 may use the object beam and the reference pattern image Sample_ref to generate a 3D hologram. The 3D hologram of the subject may be generated through holography using the object beam and the reference pattern image Sample_ref. The reference pattern image Sample_ref may be obtained by optically splitting the light modulation pattern irradiated by the light irradiation unit 100. Also, the reference pattern image Sample_ref may utilize the object beam that is previously obtained by a light receiving sensor in the hybrid optical sensor 300. The texture processing unit 420 may transmit an output image Image_out including the generated 2D texture and 3D hologram to the texture classifying unit 430.

Also, the texture processing unit 420 may compare the 2D subject image with the 2D subject image including the light modulation pattern Pattern_mod and output a process result. When the light modulation pattern Pattern_mod matches or resembles the texture of a subject, the texture processing unit 420 may generate the 2D texture and the 3D hologram of the subject. That is, the texture processing unit 420 may transmit the output image Image_out to the texture classifying unit 430. The texture processing unit 420 may generate a process result that the light modulation pattern Pattern_mod matches or resembles the texture of the subject. When light modulation pattern Pattern_mod does not match or resemble the texture of the subject, the texture processing unit 420 may generate a process result that the light modulation pattern Pattern_mod does not match or resemble the texture of the subject. The process result may be transmitted to the control unit 200. When receiving the process result that the light modulation pattern Pattern_mod matches or resembles the texture of the subject, the control unit 200 may generate the synchronization control signal Ctrl_sync and the pattern control signal Ctrl_ptn to stop generating the light modulation pattern Pattern_mod. When receiving the process result that the light modulation pattern Pattern_mod does not match or resemble the texture of the subject, the control unit 200 may generate the synchronization control signal Ctrl_sync and the pattern control signal Ctrl_ptn for generating a new light modulation pattern Pattern_mod.

The texture classifying unit 420 may receive the output image Image_out from the texture processing unit 420. The output image may include the 2D texture and 3D hologram of the subject. The texture classifying unit 430 may store the 2D texture and 3D hologram of the subject. The texture classifying unit 430 may use the 2D texture and 3D hologram of the subject to map a 3D texture. The texture classifying unit 430 may classify and store the mapped 3D for enabling an easy search.

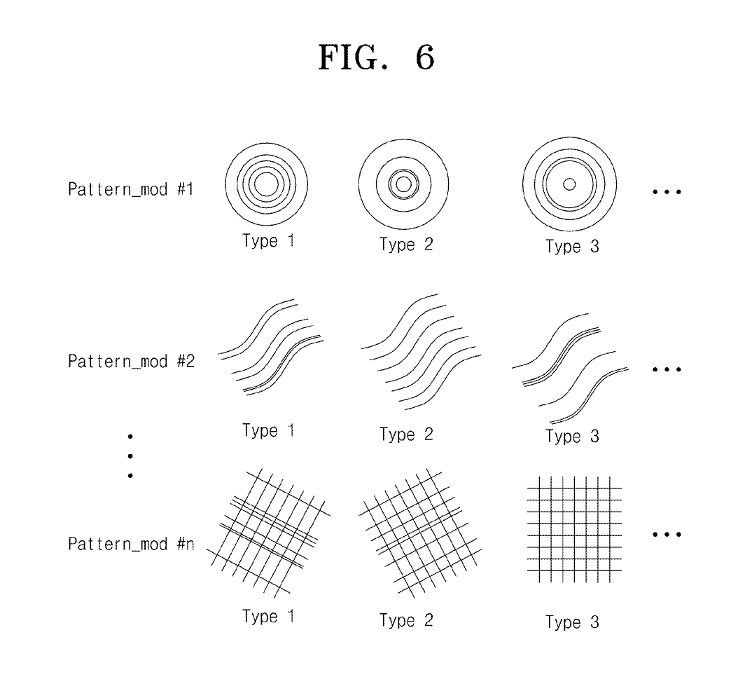

FIG. 6 illustrates a light modulation pattern generated by a light irradiation unit of FIG. 1. Referring to FIG. 6, the light irradiation unit 100 may generate various light modulation patterns Pattern_mod.

For example, a first light modulation pattern Pattern_mod #1 may include concentric circle shaped patterns. The light irradiation unit 100 may irradiate a changed light modulation pattern Pattern_mod at regular time intervals according to a process result. For the first light modulation pattern Pattern_mod #1, the light irradiation unit 100 may irradiate various types Type 1, Type 2, Type 3, etc. of the light modulation pattern Pattern_mod at regular time intervals. The light irradiation unit 100 may irradiate all types of the first light modulation pattern Pattern_mod #1 and then irradiate a second light modulation pattern Pattern_mod #2. The second light modulation pattern Pattern_mod #2 may include sinusoidal wave shaped patterns. The second light modulation pattern Pattern_mod #2 may also include various types Type 1, Type 2, Type 3, etc. of the light modulation pattern Pattern_mod. The light irradiation unit 100 may irradiate all types of the second light modulation pattern Pattern_mod #2 and then irradiate a third light modulation pattern Pattern_mod #3. The light irradiation unit 100 may irradiate a nth light modulating pattern Pattern_mod #n in such a manner. The nth light modulation pattern Pattern_mod #n may include lattice shaped patterns. The nth light modulation pattern Pattern_mod #n may also include various types Type 1, Type 2, Type 3, etc. of the light modulation pattern Pattern_mod. The shape of the light modulation pattern Pattern_mod is not limited to those described above. Until finding the same or similar light modulation pattern Pattern_mod as the texture of a subject according to a process result of the texture recognition unit 400, the light irradiation unit 100 may continue to generate irradiate a changed light modulation pattern Pattern_mod.

FIG. 7 illustrates a method of obtaining an image input signal by a texture recognition unit of FIG. 1. Referring to FIG. 7, the texture recognition unit 400 may receive the image input signal at a time determined according to the synchronization control signal Ctrl_sync. The light irradiation unit 100 may irradiate, to a subject, different light modulation patterns Pattern_mod at times t=0, t=2, and t=4 according to the synchronization control signal Ctrl_sync and the pattern control signal Ctrl_ptn. Thus, the texture recognition unit 400 may receive 2D subject images including light modulation patterns Pattern_mod at times t=0, t=2, and t=4 according to the synchronization control signal Ctrl_sync. The light irradiation unit 100 may not irradiate the light modulation pattern Pattern_mod at times t=1 and t=3 according to the synchronization control signal Ctrl_sync and the pattern control signal Ctrl_ptn. Thus, the texture recognition unit 400 may receive 2D subject images at times t=1 and t=3 according to the synchronization control signal Ctrl_sync. The texture recognition unit 400 may compare the 2D subject images and the 2D subject images including the light modulation patterns Pattern_mod that are received at different times, and generate a process result. When the light modulation pattern Pattern_mod matches or resembles the texture of the subject, the texture recognition unit 400 may recognize the 2D texture of the subject. The texture recognition unit 400 may store a recognized 2D texture. In this case, the texture recognition unit 400 may output the process result to stop generating the light modulation pattern Pattern_mod. If recognizing the 2D texture, the texture recognition unit 400 may use the object beam and the reference pattern image to generate a 3D hologram of the subject. The texture recognition unit 400 may store the 3D hologram. The texture recognition unit 400 may use the 2D texture and 3D hologram to map a 3D texture. The texture recognition unit 400 may store a mapped 3D texture. The mapped 3D texture may be used for enabling an easy search for the subject. Thus, the automatic texture recognition apparatus may utilize both 2D based texture information and 3D based texture information for processing and classifying a texture.

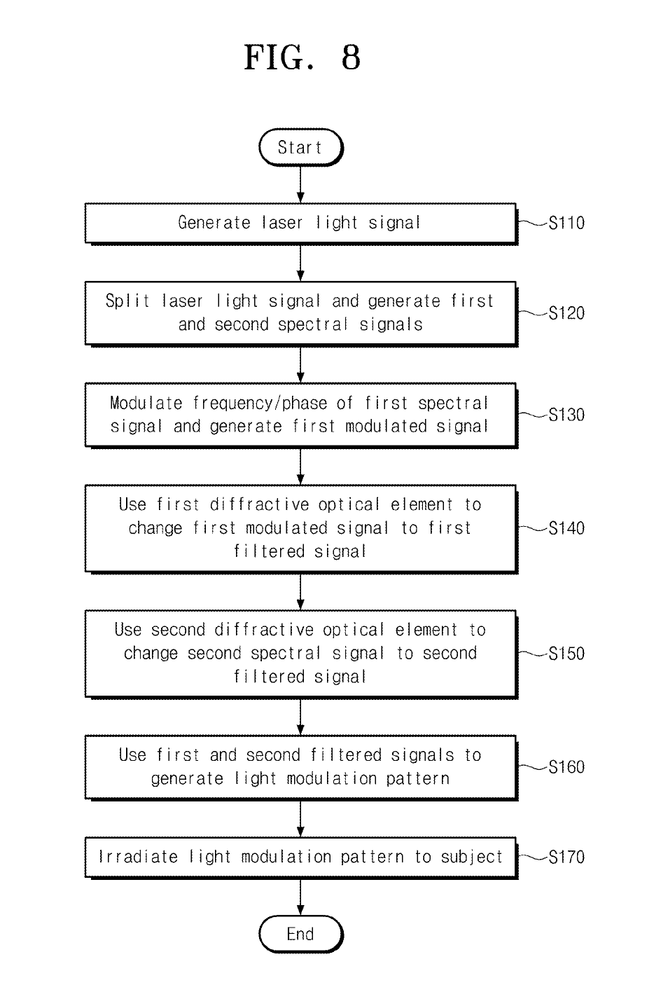

FIG. 8 is a flow chart of a method of generating a light modulation pattern by a light irradiation unit of FIG. 2. Referring to FIGS. 2 and 8, the light irradiation unit 100 may generate a light modulation pattern Pattern_mod according to the synchronization control signal Ctrl_sync and the pattern control signal Ctrl_ptn.

In step S110, the laser unit 110 may generate the laser light signal L0. The laser unit 110 may determine the frequency and phase of the laser light signal L0 according to the pattern control signal Ctrl_ptn. The laser unit 110 may determine the output time of the laser light signal L0 according to the synchronization control signal Ctrl_sync.

In step S120, the beam splitter 120 may split the laser light signal L0 into a first and a second spectral signal L01 and L02. The first and the second spectral signals may have the same frequency and phase. The first spectral signal L01 may be transmitted to the frequency/phase modulator 130. The second spectral signal L02 may be transmitted to the second diffractive optical element 150.

In step S130, the frequency/phase modulator 130 may modulate the frequency or phase of the first spectral signal L01 according to the pattern control signal Ctrl_ptn and generate a first modulated signal M01. The frequency/phase modulator 130 may make the frequency or phase of the first modulated signal M01 different from that of the first spectral signal L01 in order to generate various light modulation patterns Pattern_mod. The frequency/phase modulator 130 may transmit the first modulated signal M01 to the first diffractive optical element 140 according to the synchronization control signal Ctrl_sync.

In step S140, the first diffractive optical element 140 may change the first modulated signal M01 to the first filtered signal F01 according to the pattern control signal Ctrl_ptn. The first diffractive optical element 140 may distribute the first modulated signal M01 or change the shape or intensity of the first modulated signal M01, through active filtering. It is possible to generate more various light modulation patterns Pattern_mod through the active filtering. The first filtered signal F01 changed in such a manner may be transmitted to the optical scanner 160 according to the synchronization control signal Ctrl_sync.

In step S150, the second diffractive optical element 150 may change the second spectral signal L02 to the second filtered signal F02 according to the pattern control signal Ctrl_ptn. The second diffractive optical element 150 may distribute the second spectral signal L02 or change the shape or intensity of the second spectral signal L02, through the active filtering. It is possible to generate more various light modulation patterns Pattern_mod through the active filtering. The second filtered signal F02 changed in such a manner may be transmitted along with the first filtered signal F01 to the optical scanner 160 according to the synchronization control signal Ctrl_sync.

In step S160, the optical scanner 160 may receive the first and the second filtered signals F01 and F02 together by the synchronization control signal Ctrl_sync. The optical scanner 160 may combine the first and the second filtered signals F01 and F02 to generate the light modulation pattern Pattern_mod. The light modulation pattern Pattern_mod may be variously generated according to the pattern control signal Ctrl_ptn.

In step S170, the optical scanner 160 may irradiate a generated light modulation pattern Pattern_mod to a subject. The light modulation pattern Pattern_mod may be variously generated through steps S130 to S150.

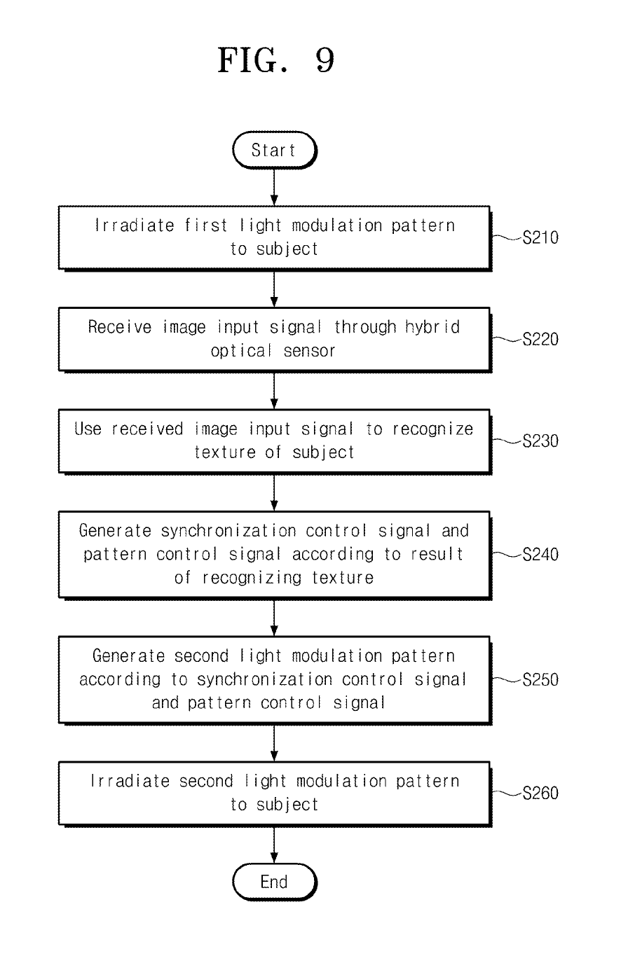

FIG. 9 is a flow chart of the operation method of an automatic texture recognition apparatus of FIG. 1. Referring to FIGS. 1 and 9, the automatic texture recognition apparatus may generate a new light modulation pattern Pattern_mod according to a process result by the texture recognition unit 400.

In step S210, the light irradiation unit 100 may irradiate the first light modulation pattern to the subject according to the synchronization control signal Ctrl_sync and the pattern control signal Ctrl_ptn.

In step S220, the hybrid optical sensor 300 may take an image of the subject according to the synchronization control signal Ctrl_sync. The hybrid optical sensor 300 may take an image of the subject and transmit an image input signal to the texture recognition unit 400. The texture recognition unit 400 may receive the image input signal according to the synchronization control signal Ctrl_sync. The image input signal may include a 2D subject image and a 2D subject image including the first light modulation pattern.

In step S230, the texture recognition unit 400 may use the image input signal to recognize a 2D texture of the subject. The image input signal may include the 2D subject image and the 2D subject image including the first light modulation pattern. The texture recognition unit 400 may compare the 2D subject image with the 2D subject image including the first light modulation pattern and recognize the 2D texture of the subject.

When the first light modulation pattern matches or resembles the texture of the subject, the texture recognition unit 400 may recognize the 2D texture of the subject. When the first light modulation pattern does not match or resemble the texture of the subject, the texture recognition unit 400 may output a process result that the first light modulation pattern does not match or resemble the texture of the subject.

In step S240, the texture recognition unit 400 transmits the process result to the control unit 200 according to a result of recognizing the texture in step S230. The control unit 200 may generate the synchronization control signal Ctrl_sync and the pattern control signal Ctrl_ptn according to a received process result. When receiving the process result that the first light modulation pattern does not match or resemble the texture of the subject, the control unit 200 may generate the synchronization control signal Ctrl_sync and the pattern control signal Ctrl_ptn for generating a new, second light modulation pattern.

In step S250, the light irradiation unit 100 receives the synchronization control signal Ctrl_sync and the pattern control signal Ctrl_ptn that are generated in step S240. The light irradiation unit 100 may generate the new, second light modulation pattern according to the synchronization control signal Ctrl_sync and the pattern control signal Ctrl_ptn.

In step S260, the light irradiation unit 100 may irradiate the second light modulation pattern to the subject. Until it is determined that the light modulation pattern matches or resembles the texture of the subject, the automatic texture recognition apparatus may repetitively perform steps S210 to S260. When the light modulation pattern matches or resembles the texture of the subject, the automatic texture recognition apparatus may store a recognized 2D texture.

If recognizing the 2D texture, the texture recognition unit 400 may use an object beam and a reference pattern image to generate a 3D hologram of the subject. The automatic texture recognition apparatus may store a generated 3D hologram. The automatic texture recognition apparatus may use the 2D texture and 3D hologram to map a 3D texture. The automatic texture recognition apparatus may store a mapped 3D texture. The mapped 3D texture may be used to enable the subject to be easily searched for. Thus, the automatic texture recognition apparatus may utilize both 2D based texture information and 3D based texture information for processing and classifying a texture.

According to the above-described embodiments of the present invention, it is possible to provide an automatic texture recognition apparatus and method that uses a regularly irradiated light modulation pattern to recognize the 2D texture of the subject and obtains 3D texture information based on holography.

Best embodiments are described in the drawings and the disclosure as described above. Although specific terms are used herein, they are only intended to describe the present invention and are not intended to limit meanings or the scope of the present invention described in the following claims. Therefore, a person skilled in the art may understand that various variations and equivalent embodiments may be implemented. Thus, the true protective scope of the present invention will be defined by the technical spirit of the following claims.

What is claimed is:

1. An automatic texture recognition apparatus comprising:
a light irradiation unit irradiating, to a subject, a light modulation pattern generated according to a synchronization control signal and a pattern control signal;
a hybrid optical sensor taking an image of the subject to generate an image input signal;
a texture recognition unit using the image input signal to recognize a 2D texture of the subject; and
a control unit generating the synchronization control signal and the pattern control signal,
wherein the texture recognition unit transmits a process result according to whether the 2D texture of the subject is recognized,
wherein the control unit generates the pattern control signal and the synchronization control signal for changing the light modulation pattern according to the process result, and
wherein the synchronization control signal is generated to synchronize operations of the light irradiation unit, the hybrid optical sensor, and the texture recognition unit.

2. The automatic texture recognition apparatus of claim 1, wherein the texture recognition unit comprises:
a texture input unit receiving the image input signal from the hybrid optical sensor;
a texture processing unit using the image input signal to recognize the 2D texture of the subject; and
a texture classifying unit classifying and storing the 2D texture of the subject,
wherein the image input signal comprises a first 2D subject image, a second 2D subject image comprising the light modulation pattern, an object beam and a reference pattern image.

3. The automatic texture recognition apparatus of claim 2, wherein the texture processing unit compares the first 2D subject image with the second 2D subject image comprising the light modulation pattern to recognize a 2D texture of the subject.

4. The automatic texture recognition apparatus of claim 3, wherein the texture processing unit generates a 3D hologram of the subject through holography using the object beam and the reference pattern image.

5. The automatic texture recognition apparatus of claim 4, wherein the texture processing unit generates a 3D texture of the subject by using the 2D texture and 3D hologram of the subject.

6. The automatic texture recognition apparatus of claim 5, wherein the texture classifying unit classifies and stores the 3D texture of the subject for enabling an easy search.

7. The automatic texture recognition apparatus of claim 2, wherein the texture input unit digitalizes the input image signal and transmits a digitalized signal to the texture processing unit.

8. The automatic texture recognition apparatus of claim 2, wherein the texture processing unit transmits the process result for changing the light modulation pattern when failing in recognizing the 2D texture of the subject.

9. The automatic texture recognition apparatus of claim 1, wherein the light irradiation unit comprises:
a laser unit outputting a laser light signal according to the synchronization control signal;
a beam splitter splitting the laser light signal into a first and a second spectral signal;
a frequency/phase modulator changing a frequency or phase of the first spectral signal according to the pattern control signal to generate a first modulated signal;
a first diffractive optical element performing active filtering on the first modulated signal according to the pattern control signal to generate a first filtered signal;
a second diffractive optical element performing active filtering on the second spectral signal according to the pattern control signal to generate a second filtered signal; and
an optical scanner using the first and the second filtered signals to generate the light modulation pattern.

10. The automatic texture recognition apparatus of claim 9, wherein the first and the second diffractive optical elements simultaneously transmit the first and the second filtered signals to the optical scanner according to the synchronization control signal.

11. The automatic texture recognition apparatus of claim 9, wherein the first and the second diffractive optical elements distribute the first modulated signal and the second spectral signal through the active filtering or changes shapes or intensities of the first modulated signal and the second spectral signal.

12. The automatic texture recognition apparatus of claim 9, wherein the laser unit determines the frequency or phase of the laser light signal according to the pattern control signal.

13. The automatic texture recognition apparatus of claim 1, wherein the control unit comprises:
a pattern control unit generating the pattern control signal to change the light modulation pattern according to the process result; and
a synchronization control unit generating the synchronization control signal to synchronize operations of the light irradiation unit, the hybrid optical sensor, and the texture recognition unit, according to the process result.

14. An automatic texture recognition method comprising:
generating a first light modulation pattern according to a first synchronization control signal and a first pattern control signal;
irradiating the first light modulation pattern to a subject;
taking a picture of the subject through a hybrid optical sensor and receiving a first image input signal;
using the first image input signal to recognize a 2D texture of the subject; and
generating a process result according to whether the 2D texture of the subject is recognized;
generating a second synchronization control signal and a second pattern control signal according to the process result;
generating a second light modulation pattern different from the first light modulation pattern according to the second synchronization control signal and the second pattern control signal; and
irradiating the second light modulation pattern to the subject and receiving a second image input signal through the hybrid optical sensor.

15. The automatic texture recognition method of claim 14, wherein the first image input signal comprises a first 2D subject image and a second 2D subject image comprising he first light modulation pattern, and
wherein the 2D texture of the subject texture is recognized by comparing the first 2D subject image with the second 2D subject image comprising the first light modulation pattern.

16. The automatic texture recognition method of claim 14, wherein when generating the second synchronization control signal and the second pattern control signal according to the process result, the process result corresponds to when failing in recognizing the 2D texture of the subject.
